(19) United States
(12) Patent Application Publication
(10) Pub. No.: US 2003/0067726 A1
(43) Pub. Date: Apr. 10, 2003

(54) Method and apparatus for providing ESD protection for receiver networks

(76) Inventor: Steven H. Voldman, South Burlington, VT (US)

Correspondence Address: IBM MICROELECTRONICS, INTELLECTUAL PROPERTY LAW, 1000 RIVER STREET, 972 E, ESSEX JUNCTION, VT, 05452, US

(21) Appl. No.: 09/562,819

(22) Filed: May 1, 2000

(51) Int. Cl. H02H 3/20

(52) U.S. Cl. 361/91.2

(57) ABSTRACT

An ESD circuit for receiver networks that have a feedback path. The ESD protection is included in the Feedback path to sufficiently limit the ESD event so that neither the feedback path elements nor the receiver are damaged.

### BACKGROUND

1. Technical Field of the Present Invention

The present invention generally relates to receiver networks, and more specifically to providing electrostatic discharge protection for receiver networks.

2. Background of the Present Invention

The primary focus of the semiconductor industry has been the scaling of the Metal-Oxide Silicon Effect Transistor (MOSFET) on bulk silicon to achieve CMOS chip performance and density objectives. The shrinking of MOSFET dimensions for high density, low power and enhanced performance requires reduced power-supply voltages. Scaling the MOSFET devices in the semiconductor industry also achieves higher transistor performance and better packing density in Very Large Scale Integration (VLSI) technology.

As MOSFETS scale, semiconductor process materials, design dimensions, tooling and process steps change in order to achieve design objectives and maintain a large process window for a high yielding manufacturing process.

ElectroStatic Discharge (ESD) protection has been highly influenced by both the semiconductor process changes and the reduction in power supply. The influence has resulted in the shrinking of the ESD structures, the Input/Output (I/O) circuitry, mixed-voltage interface environments, and noise isolation versus ESD tradeoffs. The reduction of areas for both the ESD circuits in combination with the I/O circuitry has resulted in making these structures more vulnerable, and ultimately, the introduction of new ESD circuits.

One such area requiring new and improved ESD circuitry are receiver networks. More specifically, current designs of receiver networks that include a feedback path are vulnerable to ESD events on the feedback path.

It would, therefore, be a distinct advantage to have an ESD circuit that would adequately protect these receiver networks from ESD events on their feedback paths. The present invention provides such an ESD circuit.

### SUMMARY OF THE PRESENT INVENTION

The present invention provides ESD protection for receiver networks having a feedback path. The ESD protection is included in the Feedback path to sufficiently limit the ESD event so that neither the feedback path elements nor the receiver are damaged.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a schematic diagram illustrating an example of a convention single feedback receiver network that can reside either internal or external to an Integrated Circuit (IC);

FIG. 2 is a schematic diagram illustrating an example of a conventional symmetric feedback receiver network that can reside either internal or external to an IC;

FIG. 3 is a schematic diagram illustrating in greater detail selected internal components of the conventional symmetric feedback receiver network of FIG. 2 in order to provide a better understanding of the problems associated with an ESD event on either of the Feedback paths;

FIG. 4 is a schematic diagram of the symmetrical feedback receiver network of FIG. 2 as modified according to the preferred embodiment of the present invention to prevent damage from ESD events on the Feedback paths;

FIG. 5 is a schematic diagram illustrating in greater detail an example of how the detail selected components of the receiver network of FIG. 4 can be implemented according to the teachings of the present invention;

FIG. 6 is a schematic diagram illustrating additional ESD components that can be included in the receiver network of FIG. 5 according to the teachings of the present invention;

FIG. 7 is a schematic diagram illustrating in greater detail an example of how the ESD devices of FIG. 4 can be implemented according to the teachings of the present invention;

FIG. 8 is a schematic diagram illustrating in greater detail an example of how the ESD devices of FIG. 4 can be distributed within the receiver network of FIG. 4 to provide appropriate impedance protection for the Pullup Feedback device, the Pulldown Feedback device, and the Receiver according to the teachings of the present inventions;

FIG. 9 is a schematic diagram illustrating in greater detail an example of how the ESD devices of FIG. 4 can be distributed within the receiver network of FIG. 4 to provide appropriate impedance protection for the Pullup Feedback device, the Pulldown Feedback device, and the Receiver according to the teachings of the present invention;

FIG. 10 is a schematic diagram of a convention receiver network 1000 used for hysterisis effects;

FIG. 11 is a schematic diagram of the receiver network of FIG. 10 as modified to provide ESD protection according to the teachings of the present invention;

FIG. 12 is a schematic diagram of the modified receiver network of FIG. 11 illustrating an example of how the ESD protection can be implemented according to the teachings of the present invention; and

FIG. 13 is a schematic diagram of the modified receiver network of FIG. 11 illustrating another example of how the ESD protection can be implemented according to the teachings of the present invention.

### DETAILED DESCRIPTION OF THE PREFERRED EMBODIMENT OF THE PRESENT INVENTION

In the following description, numerous specific details are set forth, however, it will be obvious to those of ordinary skill in the art that the present invention can be practiced with different details. In other instances, well-know circuits have been shown in block diagram form in order not to obscure the present invention in unnecessary detail. For the most part, details concerning timing considerations and the like have been omitted inasmuch as such details are not necessary to obtain a complete understanding of the present invention, and are within the skills of persons of ordinary skill in the relevant art.

Definitions

The following terms as used herein have the meanings defined below.

VDD—a digitized or analog signal can be part of the circuitry of the Integrated Circuit (IC) or an isolated peripheral rail independent of the internal circuitry. In example, VDD can be an external Input/Output power rail, or core VDD.

VSS—the chip substrate ground or an independent power source.

ESD Device—any device that can protect an intended element from an Electro Static Discharge (ESD) event. In example, an ESD device could be a diode, an NFET, a polybounded diode, an SOI diode, a Silicon Controlled Rectifier, or PNP.

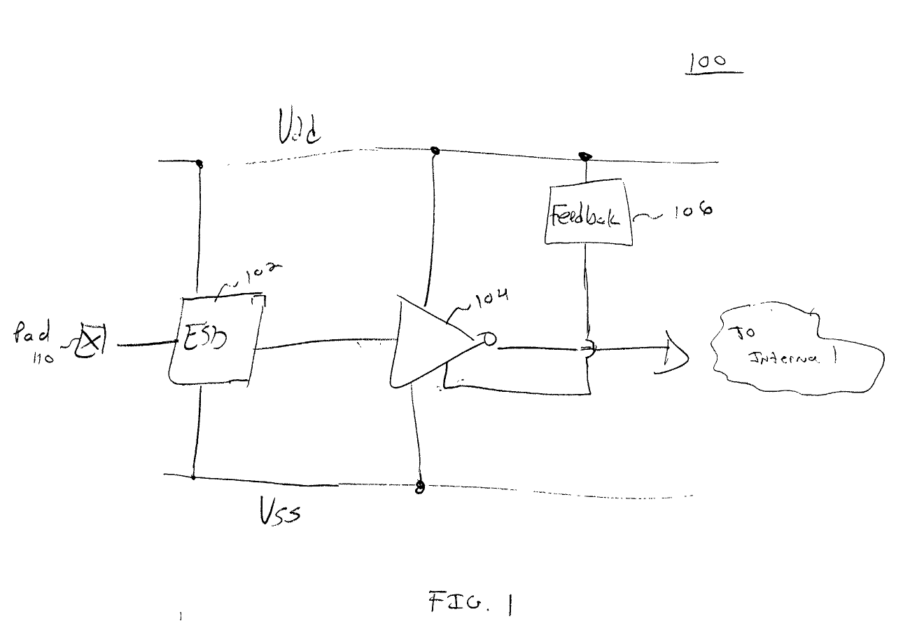

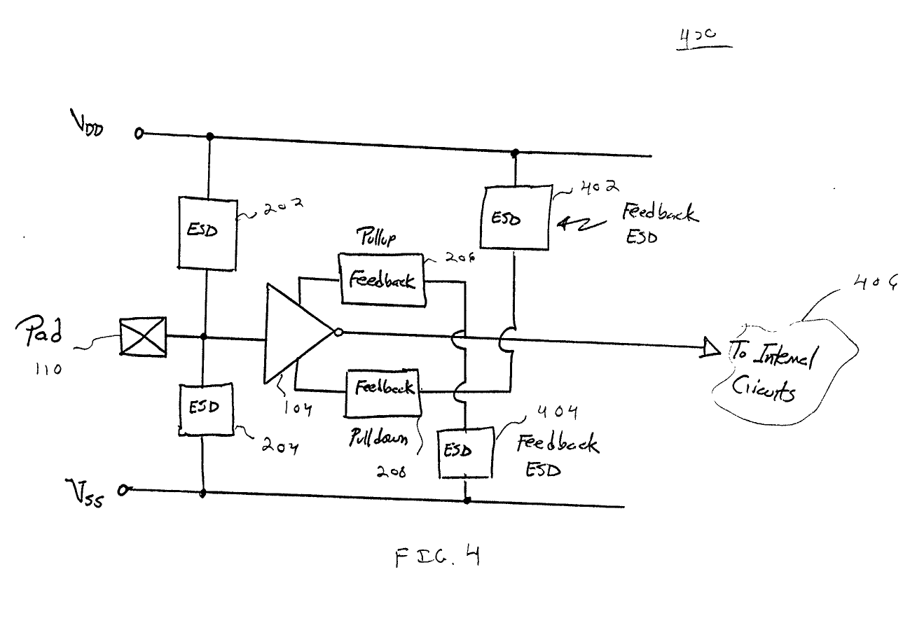

The present invention is best understood by providing examples of the ESD problems associated with conventional receiver networks having feedback circuits (FIGS. 1-3 and 10), and then explaining how to overcome these problems (FIGS. 4-9 and 11-13). Any conventional receiver network having a feedback path has the potential for a damaging ESD event on the feedback path.

FIG. 1 is a schematic diagram illustrating an example of a convention single feedback receiver network 100 that can reside either internal or external to an Integrated Circuit (IC). The receiver network 100 includes a Pad 110, an Electro Static Discharge (ESD) device 102, a Receiver (inverter) 104, and a Feedback device 106. The Pad 110 is used for receiving input and transmitting the received information to the ESD device 102 which in turn is fed to the Receiver 104. The Receiver 104 feeds the received information to other internal circuitry 108, and receives signals from Feedback device 106. The Feedback device 106 provides stability and hysteresis for the Receiver 104 during a functional event. The ESD device 102 is intended to protect the Receiver 104 from positive ESD events. The power rail is designated as VDD and the ground rail is designated as VSS. Power rail VDD can be an external I/O powerrail, analog VDD, core VDD, or the like.

If the receiver network 100 is embedded in a relatively small circuit, then VDD will have a very low capacitance, and as a result will become charged during an ESD event. Assuming that a positive ESD pulse occurs on the Pad 110, the ESD device 102 will discharge to VDD which will charge as a result of its capacitance. The charging of VDD will result in the Feedback device 106 being activated and providing this ESD pulse to the internals of Receiver 104. Experimental results have shown that the occurrence of such a positive ESD pulse can cause the Feedback device 106 and the internals of the Receiver 104 to sustain significant damage.

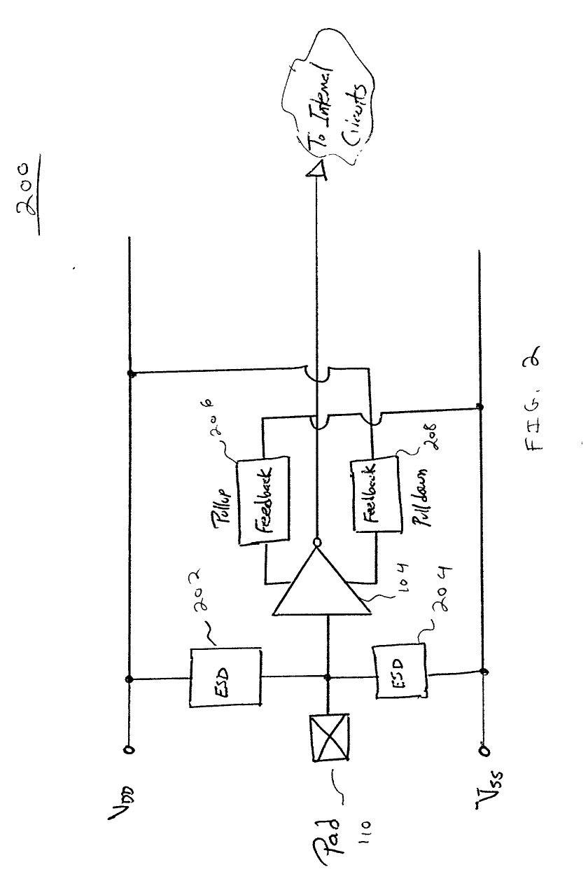

FIG. 2 is a schematic diagram illustrating an example of a conventional symmetric feedback receiver network 200 that can reside either internal or external to an IC. The receiver network 200 includes a Pad 110, two ESD devices 202 and 204, a Receiver 104, a Pullup Feedback device 206, and a Pulldown Feedback device 208. The Pad 110 and Receiver 104 serve the same function as described in connection with FIG. 1. ESD devices 202 and 204 are intended to protect the Receiver 104 from positive and negative ESD events, respectively. The Pullup and Pulldown Feedback devices 206 and 208 are coupled to the pullup and pulldown circuitry (not shown) of the Receiver 104, and are intended to provide stability and hysteresis for the Receiver 104 during a functional event.

A positive ESD event on the Pad 110 of the receiver network 200 has the same potential for causing significant damage to the Pullup Feedback device 206 as explained in connection with the receiver network 100. A negative ESD event on the Pad 110 of the receiver network 200 will result in the ESD device 204 discharging to VSS, which in turn results in the activation of the Pulldown Feedback device 208 providing the ESD pulse to the pull down circuitry of the Receiver 104. Once again, experimental results have shown that the occurrence of such a negative ESD pulse can cause significant damage to the Pulldown Feedback device 208 and the internal pulldown circuitry of the Receiver 104.

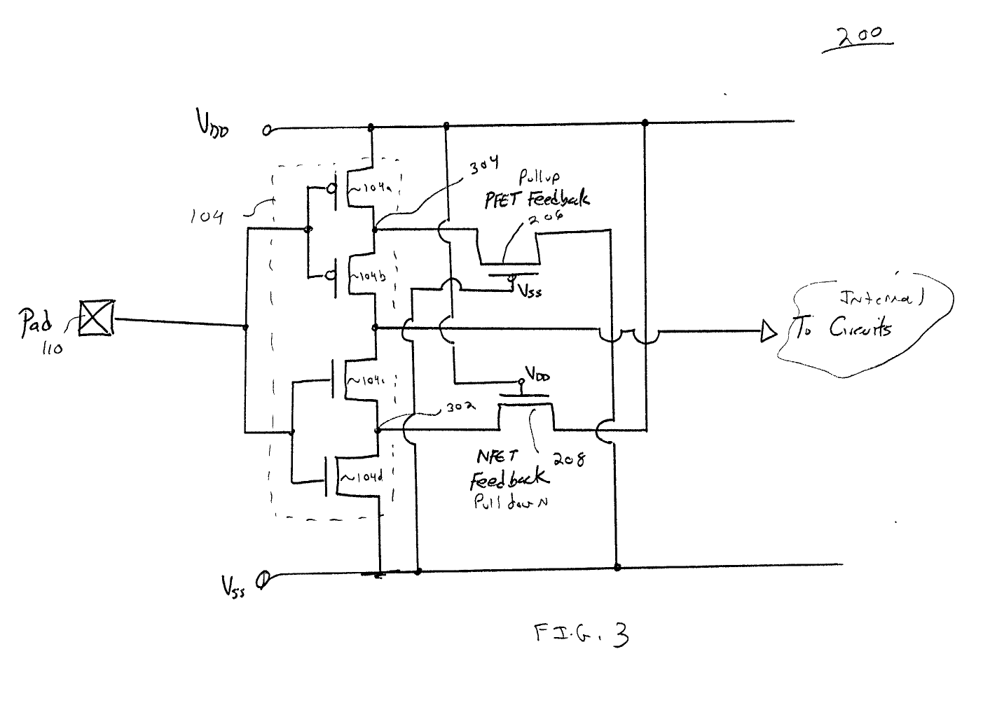

FIG. 3 is a schematic diagram illustrating in greater detail selected internal components of the conventional symmetric feedback receiver network 200 of FIG. 2 in order to provide a better understanding of the problems associated with an ESD event on either of the Feedback paths 206 or 208. As illustrated, the Receiver 104 comprises cascoded pullup PFETs 104a-b and pulldown NFETs 104c-d where the sources of the Pullup and Pulldown Feedback devices 206 and 208 are coupled to the middle nodes 304 and 302 located between the cascoded PFETs 104a-b and NFETs 104c-d, respectively. The Pullup Feedback device 206 is a PFET whose gate and drain are coupled to VSS. The Pulldown Feedback device 208 is an NFET whose gate and drain are coupled to VDD. It should be noted that the Feedback devices 206 and 208 are not coupled to either the Input pad 110 or the internal circuitry.

It should be noted that although MOSFET technology is being illustrated in the following examples that the present invention is not to be limited to MOSFET technology, but is equally applicable to other technologies such as bulk CMOS, SOI, RF-CMOS, BiCMOS, SiGe, SiGeC devices, and the like. For example, in bulk CMOS technology, the body of the NFETs 208, 104a, and 104d can be connected to the p-well or substrate VSS, and the PFETs 104a, b and 206 can be connected to an n-well at VDD. In yet another example, in SOI technology the above connections noted for bulk CMOS can be implemented and the bodies of the noted devices could be floating and either single gate or dual gate.

During a positive ESD pulse on the Pad 110, the ESD device 202 (FIG. 2) will provide current to VDD (assuming VSS is grounded) which will flow through the NFET 208 to node 302, and to NFET 104d to ground. When the voltage on VDD exceeds the sum of the snap back voltages of the NFET 208 and NFET 104d, excessive current will flow through these elements resulting in internal failure of the NFETs 208 and 104d. In a similar fashion, during a negative ESD pulse on the Pad 110, the ESD device 204 will provide current to VSS (assuming Vdd is grounded) which will flow through the PFET 206 to node 304, and to PFET 104a to VDD. When the voltage on VSS exceeds the sum of the snap back voltages of the PFET 206 and PFET 104a, excessive current will flow through these elements resulting in internal failure of the PFETs 206 and 104a.

The potential of damage from an ESD event on the feedback paths of a receiver network can be significantly reduced by the introduction of an ESD device into the feedback path as illustrated below.

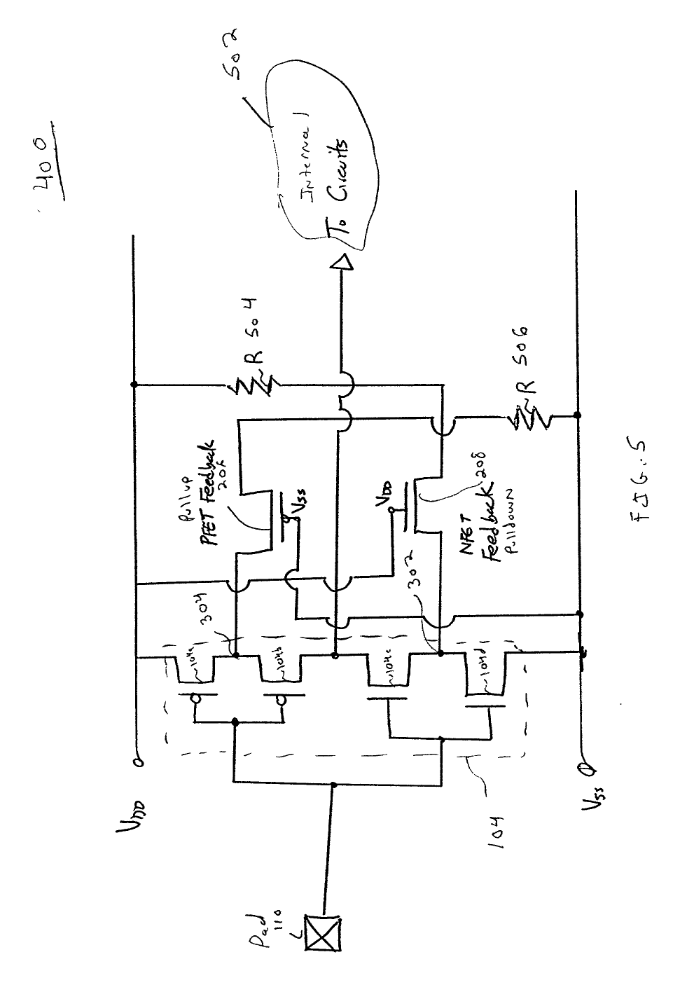

FIG. 4 is a schematic diagram of the symmetrical feedback receiver network 200 of FIG. 2 as modified according to the preferred embodiment of the present invention to prevent damage from ESD events on the Feedback paths 206 and 208. The receiver network 400 has been modified by the addition of the Voldman Feedback ESD devices 402 and 404. Voldman Feedback ESD devices 402 and 404 prevent snapback during a positive and negative ESD pulse event for the Pullup Feedback device 206, the Pulldown Feedback device 208, and the Receiver 104. The Voldman Feedback ESD devices 402 and 404 can be implemented in many different fashions as illustrated by FIGS. 5-9. It should be noted that although the Feedback ESD devices 402 and 404 have been illustrated in a specified location within the network 400, they could, in fact, be located anywhere within the circuit so long as they provide impedance which isolates the Pullup and Pulldown Feedback devices 206 and 208 and the Receiver 104.

FIG. 5 is a schematic diagram illustrating in greater detail an example of how the detail selected components of the receiver network 400 of FIG. 4 can be implemented according to the teachings of the present invention. In this particular example, the Voldman Feedback ESD devices 402 and 404 have been implemented as resistive elements 504 and 506, respectively. The Resistive elements 504 and 506 result in a voltage drop that in turn restricts the amount of current that an ESD event provides to a level that is sustainable by the affected devices. For example, on a positive ESD pulse on the Pad 110, the Resistive element 504 limits the amount of current to the NFETS 208 and 104d to a sustainable amount. The Resistive elements 504 and 506 can be any type of resistor (e.g. N+, P+, polysilicon, n-well resistor, a “on” MOSFET transistor).

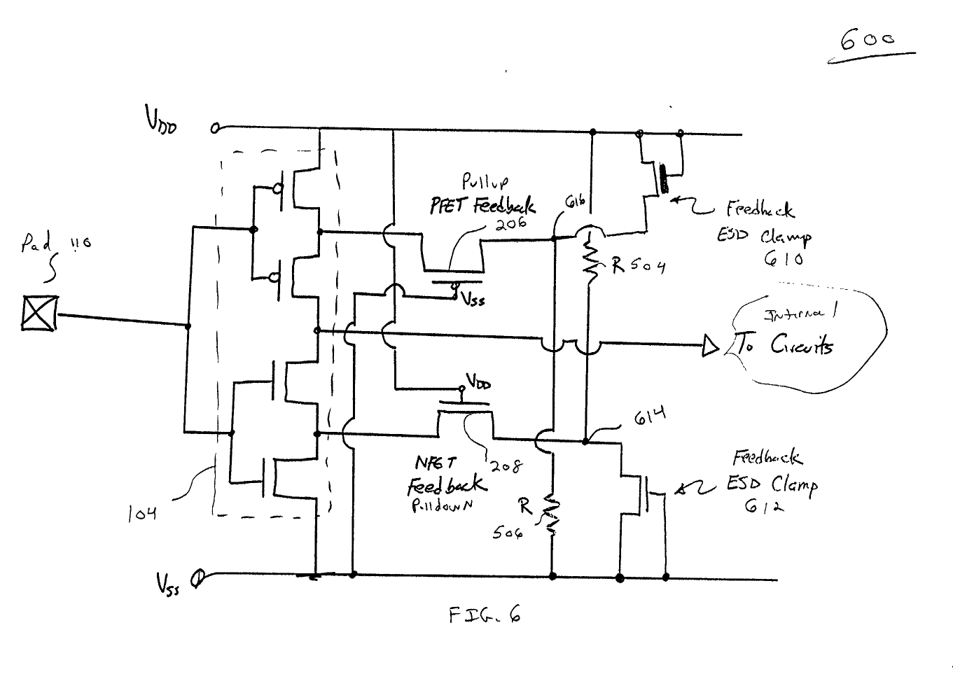

FIG. 6 is a schematic diagram illustrating additional ESD components 610 and 612 that can be included in the receiver network 400 of FIG. 5 according to the teachings of the present invention. In this example, two additional Feedback ESD clamps 610 and 612 have been added to the receiver network 600. The function of the additional ESD clamps 610 and 612 are best explained in connection with the occurrence of an ESD event. During a positive pulse ESD event on Pad 110, the ESD device 202 discharges to VDD. The discharge to VDD results in current flowing through the Resistive element 504 charging the input node 614 of NEFT 612 until it reaches the snapback voltage of the NFET 208. When the snapback voltage is reached at input node 614, the Feedback ESD clamp 612 discharges to VSS, thus, providing a resistor divider network formed of Resistive element 504 and Feedback ESD clamp 612. The Feedback ESD clamp 610 serves the same function as described in connection with the Feedback ESD clamp 612 for a negative pulse ESD event.

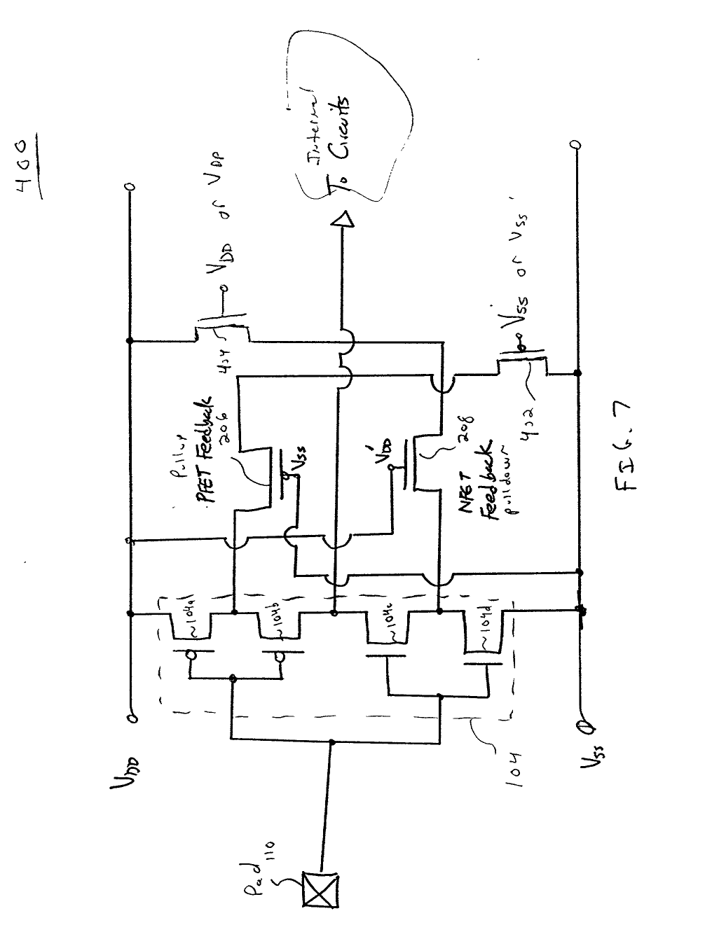

FIG. 7 is a schematic diagram illustrating in greater detail an example of how the ESD devices 402 and 404 of FIG. 4 can be implemented according to the teachings of the present invention. In this example, ESD devices 402 and 404 have been implemented using a NFET and PFET, respectively. The gates of the NFET 404 and PFET 402 have been tied to VDD and VSS, respectively. During an ESD event the NFET 404 (positive event) or PFET 402 (negative event) limits the amount of current. For example, during a positive ESD event on Pad 110, the ESD device 202 discharges to VDD. If the gate of the NFET 404 is tied to VDD, then the NFET 404 will turn on providing a resistance between VDD and NFET Feedback pulldown 208. If the gate of the NFET 404 is not tied to the same rail as VDD (VDD′), then the NFET 404 remains off, and will only provide current until it goes into snapback mode. In the case of snapback mode, the NFET 404 will add an additional voltage drop prior to the snapback of NFETs 208 and 104d. PFET 402 serves the same function as described above in connection with NFET 404 for a negative ESD event for PFETs 206 and 104a.

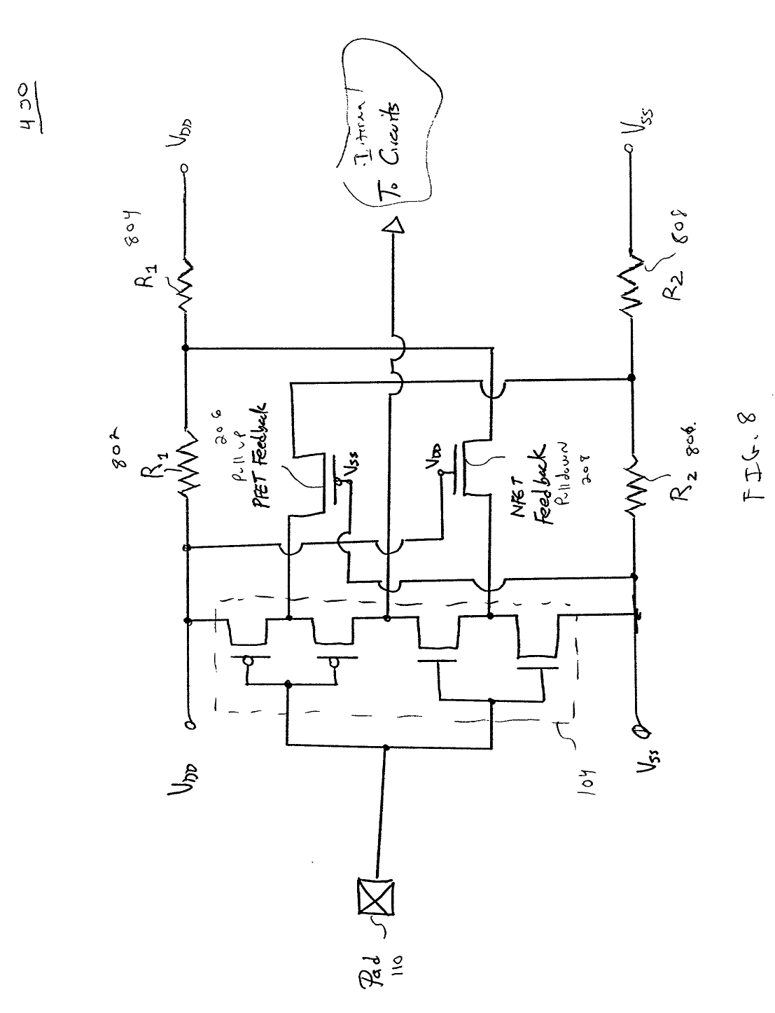

FIG. 8 is a schematic diagram illustrating in greater detail an example of how the ESD devices 402 and 404 of FIG. 4 can be distributed within the receiver network 400 of FIG. 4 to provide appropriate impedance protection for the Pullup Feedback device 206, the Pulldown Feedback device 208, and the Receiver 104 according to the teachings of the present invention. In this example, ESD device 402 is represented by Resistive elements R1 802 and R1 804, and ESD device 404 is represented by Resistive elements R2 806 and R2 808. During a positive ESD event, the Resistive elements R1 802 and R1 804 limit the amount of current flowing to the NFET Feedback pulldown 208 to an acceptable level. During a negative ESD event, the Resistive elements R2 806 and R2 808 limit the amount of current flowing to the PFET Feedback pullup 206 to an acceptable level.

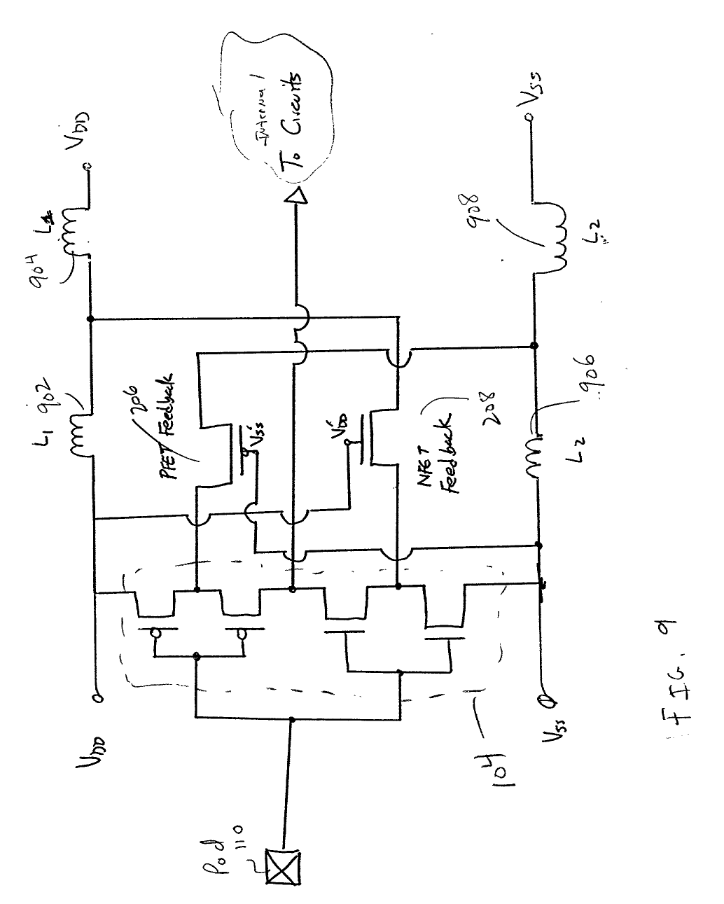

FIG. 9 is a schematic diagram illustrating in greater detail an example of how the ESD devices 402 and 404 of FIG. 4 can be distributed within the receiver network 400 of FIG. 4 to provide appropriate impedance protection for the Pullup Feedback device 206, the Pulldown Feedback device 208, and the Receiver 104 according to the teachings of the present invention. In this example, ESD device 402 is represented by Inductive elements L1 902 and L1 904, and ESD device 404 is represented by Inductive elements L2 906 and L2 908. During a positive ESD event, the Inductive elements L1 902 and L1 904 limit the amount of current flowing to the NFET Feedback pulldown 208 to an acceptable level. During a negative ESD event, the Inductive elements L2 906 and L2 908 limit the amount of current flowing to the PFET Feedback Pullup 206 to an acceptable level.

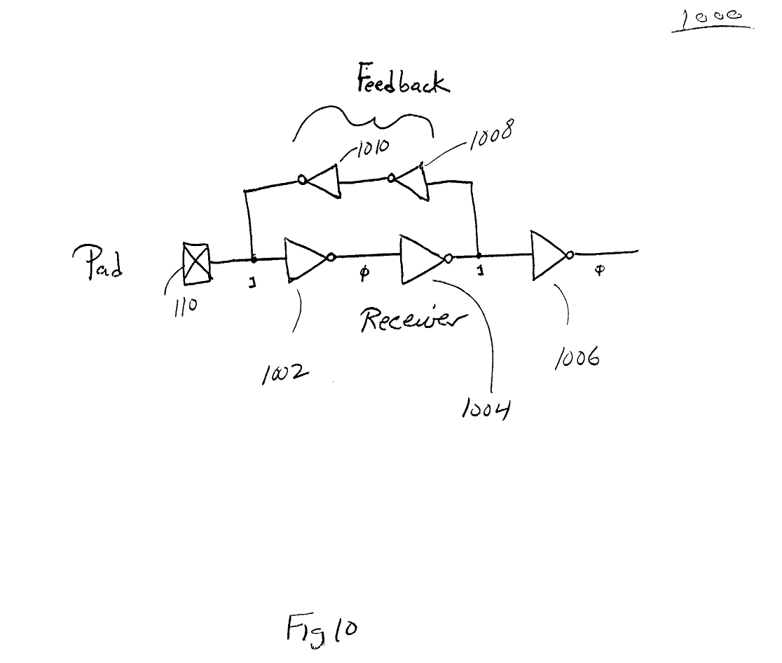

FIG. 10 is a schematic diagram of a convention receiver network 1000 used for hysterisis effects. The receiver network 1000 includes a chain of Receivers 1002-1006 the output of each feeding a subsequent Receiver. The receiver network 1000 also includes a feedback loop comprised of Receivers 1008 and 1010. Receiver 1008 is coupled to the output of Receiver 1004 and to the input of Receiver 1010. The output of Receiver 1010 is coupled to the input of Receiver 1002. During an ESD pulse event on Pad 110, the ESD pulse will be seen by both Receivers 1002 and 1010 (feedback). In this scenario, the Feedback Receiver 1010 can limit the ESD protection, if any, provided to the Receiver 1002.

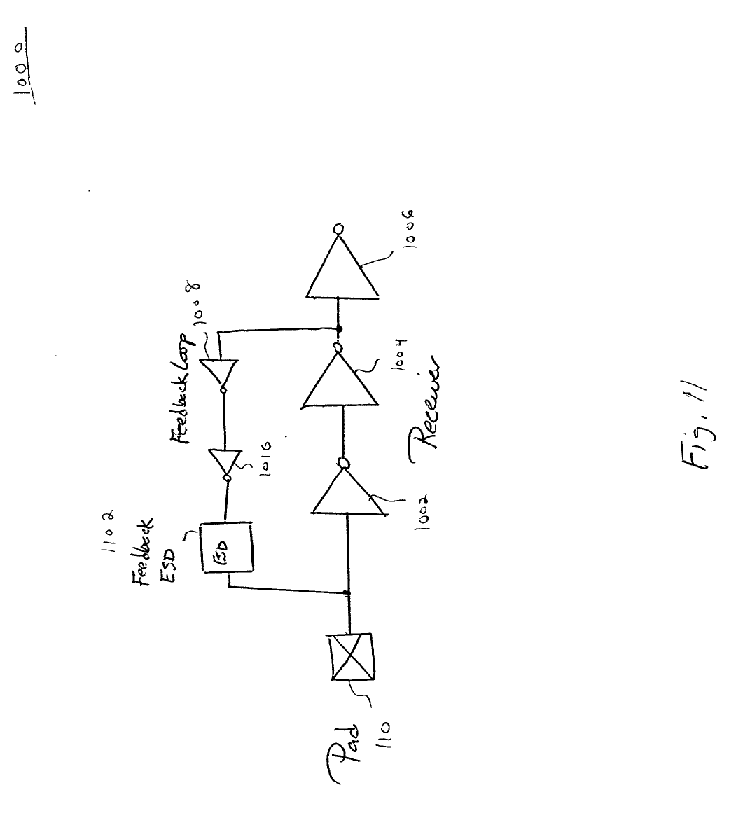

FIG. 11 is a schematic diagram of the receiver network 1000 of FIG. 10 as modified to provide ESD protection according to the teachings of the present invention. A feedback ESD device 1102 has been added between Receivers 1010 and 1002 to provide the appropriate ESD protection to 1002.

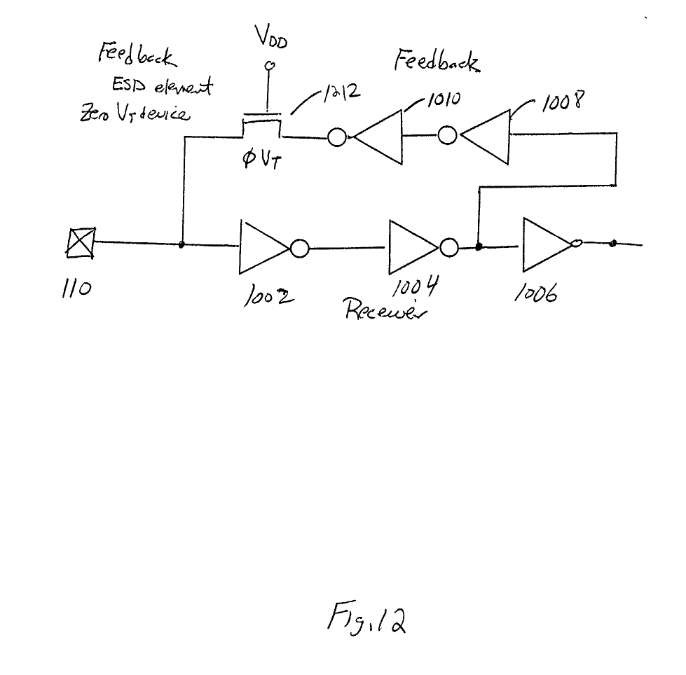

FIG. 12 is a schematic diagram of the modified receiver network 1000 of FIG. 11 illustrating an example of how the ESD protection can be implemented according to the teachings of the present invention. The Feedback ESD device 1102 has been implemented as a zero Vt device. The Feedback ESD device 1102 could also be implemented as a resistive element and server the same function.

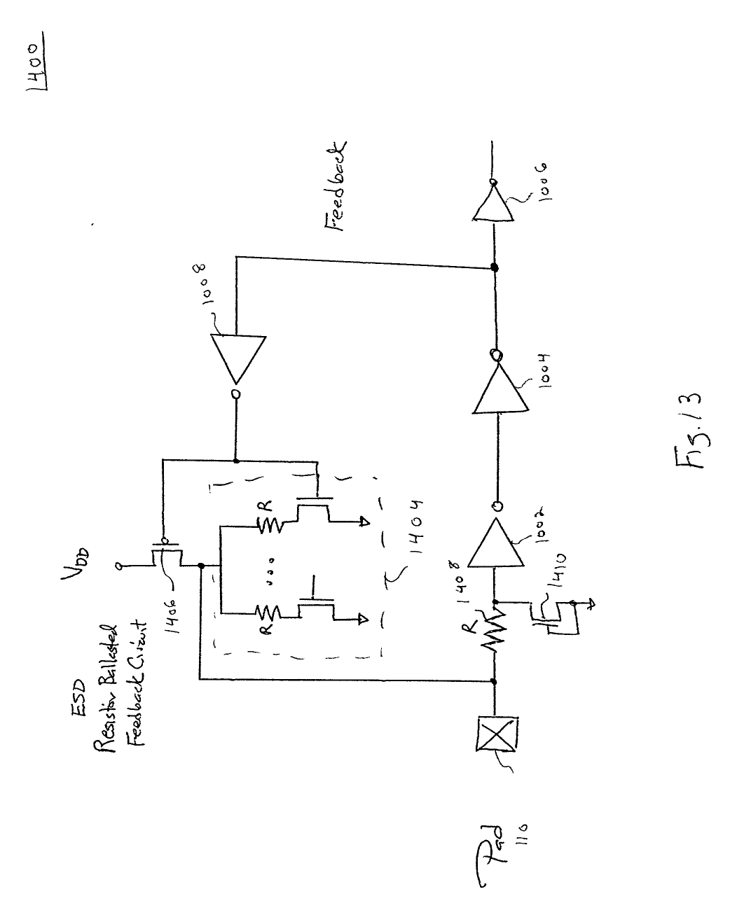

FIG. 13 is a schematic diagram of the modified receiver network 1000 of FIG. 11 illustrating another example of how the ESD protection can be implemented according to the teachings of the present invention. In this example, Receiver 1010 has been replaced with a resistor ballasted NFET pull down 1404 in combination with PFET 1406. In addition, Resistive element 1408 and grounded gate NFET 1410 have been added to the input of Receiver 1002 to provide ESD protection.

It is thus believed that the operation and construction of the present invention will be apparent from the foregoing description. While the method and system shown and described has been characterized as being preferred, it will be readily apparent that various changes and/or modifications could be made wherein without departing from the spirit and scope of the present invention as defined in the following claims.

What is claimed is:

1. A circuit comprising:
a first feedback source;
a first feedback device; and
a first ESD device coupled between the first feedback source and the first feedback device for providing ESD protection of the first feedback device.

2. The circuit of claim 1 further comprising:
a receiver coupled to the first ESD device.

3. The circuit of claim 2 wherein the first feedback source is power.

4. The circuit of claim 2 wherein the first feedback source is ground.

5. The circuit of claim 2 further comprising:
a second feedback source;
a second feedback device; and
a second ESD device coupled between the second feedback source and the second feedback device for providing ESD protection of the second feedback device.

6. The circuit of claim 5 wherein the receiver is a an inverter having cascoded PFETs and cascoded NFETs.

7. The circuit of claim 6 wherein the first feedback device is a PFET having its source coupled to the junction of the cascoded PFETs, and both its gate and drain coupled to the second feedback source.

8. The circuit of claim 7 wherein the second feedback device is an NFET having its source coupled to the junction of the cascoded NFETs, and both its gate and drain coupled to the first feedback source.

9. The circuit of claim 8 wherein the first and second ESD devices are resistive elements.

10. The circuit of claim 8 wherein the first and second ESD devices are a PFET and NFET, respectively.

11. The circuit of claim 8 wherein the first and second ESD devices are resistor divider networks located in the first and second feedback sources, respectively.

12. A circuit comprising:
a receiver having an input, an output, a first feedback input, and a second feedback input;
a first feedback source;
a first feedback device coupled to the first feedback input; and
a first ESD device, coupled between the first feedback source and first feedback device, for providing ESD protection to the first feedback device.

13. The circuit of claim 13 further comprising:
a second feedback source;
a second feedback device coupled to the second feedback input; and
a second ESD device, coupled between the second feedback source and the second feedback device, for
providing ESD protection to the second feedback device.

14. The circuit of claim 13 wherein the first and second feedback sources are power and ground,
respectively.

15. The circuit of claim 14 wherein the receiver is a an inverter having cascoded PFETs and cascoded NFETs.

16. The circuit of claim 15 wherein the first feedback device is a PFET having its source coupled to the junction of the cascoded PFETs, and both its gate and drain coupled to the second feedback source.

17. The circuit of claim 16 wherein the second feedback device is an NFET having its source coupled to the junction of the cascoded NFETs, and both its gate and drain coupled to the first feedback source.

18. The circuit of claim 17 wherein the first and second ESD devices are resistive elements.

19. The circuit of claim 17 wherein the first and second ESD devices are a PFET and NFET, respectively.

20. The circuit of claim 17 wherein the first and second ESD devices are resistor divider networks located in the first and second feedback sources, respectively.
